(19) United States
(12) Patent Application Publication
(10) Pub. No.: US 2007/0163065 A1
(43) Pub. Date: Jul. 19, 2007

(54) Extendible cleaner rod

(76) Inventor: Jia Long Chang, Fenyuan Hsiang (TW)

Correspondence Address: CHARLES E. BAXLEY, ESQ., 90 JOHN STREET, THIRD FLOOR, NEW YORK, NY, 10038, US

(21) Appl. No.: 11/335,738

(22) Filed: Jan. 19, 2006

(51) Int. Cl. B25G 1/04

(52) U.S. Cl. 15/144.4; 15/120.1; 16/429

(57) ABSTRACT

An extendible cleaner rod includes a fixed coupler for attaching to a base tube and having a sleeve member extended from a base portion, the sleeve member includes one or more slots to form one or more blades, the blades each includes an inclined surface, an extending tube is engaged into the sleeve member of the fixed coupler, and a rotatable coupler is engaged onto the sleeve member and includes one or more protrusions each having an inclined surface for engaging with the inclined surface of the blades and for forcing the fixed coupler and the extending tube together. The rotatable coupler may be limited to rotate relative to the fixed coupler and will not be over-rotated relative to the fixed coupler.

### BACKGROUND OF THE INVENTION

1. Field of the Invention

The present invention relates to an extendible cleaner rod, and more particularly to an extendible cleaner rod having two tubes extendible and adjustable relative to each other and releasably or detachably secured together with a rotatable coupler that is limited to rotate relative to the tubes and that may be rotatably anchored to one of the tubes.

2. Description of the Prior Art

Typical extendible cleaner rods or rod coupling devices comprise a fixed coupler attached to a base rod or tube, and another rod or tube slidably engaged onto or into the base rod or tube and rotatably or adjustably secured to base rod or tube with a rotatable fastener or lock nut, for detachably securing the rods or tubes together.

For example, U.S. Pat. No. 6,045,284 to Chiu, and U.S. Pat. No. 6,322,006 to Guo disclose two of the typical adjustable handles or extendible cleaner rods, and each also comprises a fixed coupler attached to a base rod or tube which is slidably engaged onto or into the other rod or tube and rotatably or adjustably secured to other rod or tube with a rotatable fastener or lock nut, for detachably securing the rods or tubes together.

However, the rotatable fastener or lock nut is threaded to the fixed coupler with a threading engagement, and the threading engagement may have a good chance to be damaged when the rotatable fastener or lock nut is over-rotated relative to the fixed coupler.

In addition, the rotatable fastener or lock nut is separated from the fixed coupler and will be separated or disengaged from the fixed coupler and thus the rotatable fastener or lock nut may have a good chance to be lost after use.

Furthermore, the rods or tubes should include different inner or outer diameters for allowing the rods or tubes to be slidably engaged with each other and to be adjustably secured together with the couplers. The rod or tube having a smaller inner or outer diameters may be weaker and may be easily bent or damaged. The rotatable fastener or lock nut and the fixed coupler may not be used to couple or secure two rod or tube having the same inner or outer diameters.

The present invention has arisen to mitigate and/or obviate the afore-described disadvantages of the conventional extendible cleaner rods.

### SUMMARY OF THE INVENTION

The primary objective of the present invention is to provide an extendible cleaner rod including two tubes extendible and adjustable relative to each other and releasably or detachably secured together with a rotatable coupler that is limited to rotate relative to the tubes and that will not be over-rotated relative to the tubes.

The other objective of the present invention is to provide an extendible cleaner rod including two tubes extendible and adjustable relative to each other and releasably or detachably secured together with a rotatable coupler that may be rotatably. anchored to one of the tubes and that will not be separated or disengaged from the tubes.

In accordance with one aspect of the invention, there is provided an extendible cleaner rod comprising a fixed coupler for attaching to a base tube, and including a sleeve member extended from a base portion, the sleeve member including at least one slot to form at least one blade, the blade including an inclined surface formed thereon, an extending tube engaged into the sleeve member of the fixed coupler, and a rotatable coupler including a bore for rotatably engaging onto the sleeve member of the fixed coupler and including at least one protrusion extended into the bore of the rotatable coupler, the protrusion including an inclined surface for engaging with the inclined surface of the blade of the fixed coupler and for allowing the protrusion to be rotated and engaged onto the blade of the fixed coupler and for allowing the fixed coupler and the extending tube to be forced and secured together with the rotatable coupler. The rotatable coupler may be limited to rotate relative to the fixed coupler and will not be over-rotated relative to the fixed coupler.

The fixed coupler includes a flange extended from the sleeve member for engaging with the rotatable coupler and for rotatably anchoring the rotatable coupler to the sleeve member of the fixed coupler and for preventing the rotatable coupler from being disengaged from the fixed coupler.

The fixed coupler includes at least one cavity formed therein, and the rotatable coupler includes at least one projection for selectively engaging with the cavity of the fixed coupler and for anchoring and positioning the rotatable coupler to the fixed coupler at a selected angular position.

The fixed coupler includes a peripheral swelling having the cavity formed in the peripheral swelling, and the rotatable coupler includes a peripheral depression for slidably receiving the peripheral swelling of the fixed coupler and for guiding the rotatable coupler to rotate relative to the fixed coupler.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an extendible cleaner rod in accordance with the present invention;

FIG. 2 is a partial cross sectional view of the extendible cleaner rod taken along lines 2-2 of FIG. 1;

FIG. 3 is a partial exploded view illustrating the coupling members of the extendible cleaner rod;

FIG. 4 is a perspective view illustrating a rotatable coupler for the extendible cleaner rod;

FIG. 5 is a cross sectional view of the extendible cleaner rod taken along lines 5-5 of FIG. 2;

FIG. 6 is a cross sectional view similar to FIG. 5, illustrating the operation of the extendible cleaner rod;

FIG. 7 is a partial exploded view similar to FIG. 3, illustrating the other arrangement of the extendible cleaner rod;

FIG. 8 is a further partial exploded view similar to FIGS. 2 and 7, illustrating the further arrangement of the extendible cleaner rod.

### DETAILED DESCRIPTION OF THE PREFERRED EMBODIMENT

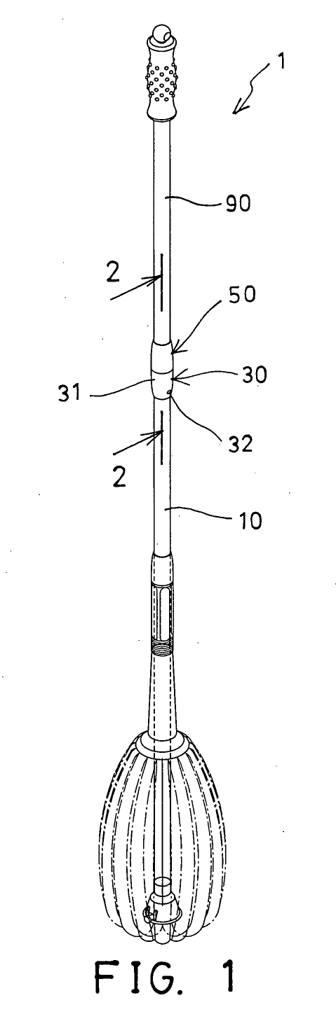

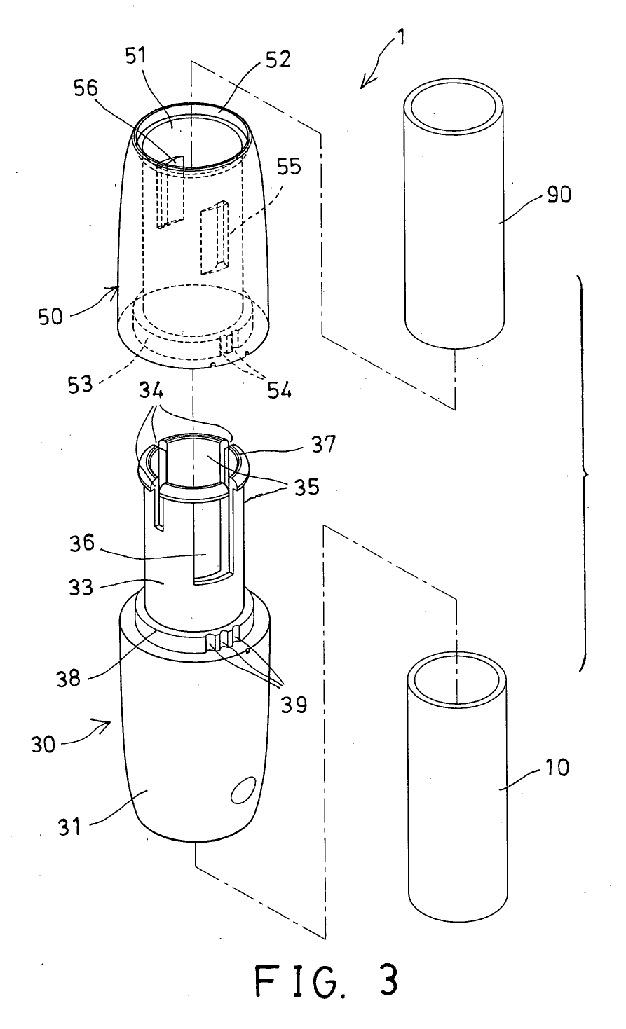

Referring to the drawings, and initially to FIGS. 1-3, an extendible cleaner rod 1 in accordance with the present invention comprises two rods or tubes 10, 90 to be detachably and adjustably secured together, a fixed coupler 30 fixed to or formed integral with one of the rods or tubes or the base tube 10, and a rotatable fastener or coupler 50 rotatably attached onto the fixed coupler 30 and the other rod or tube or extending tube 90 for releasably or detachably securing the two tubes 10, 90 together.

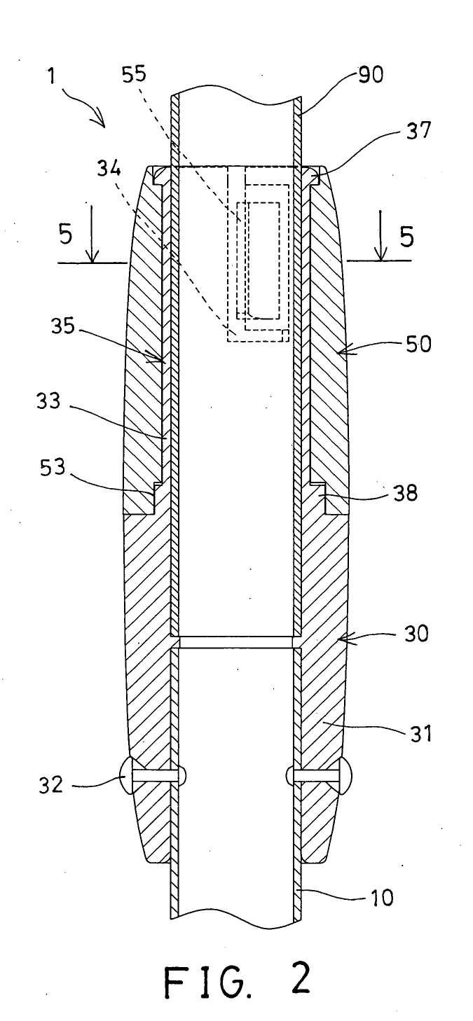

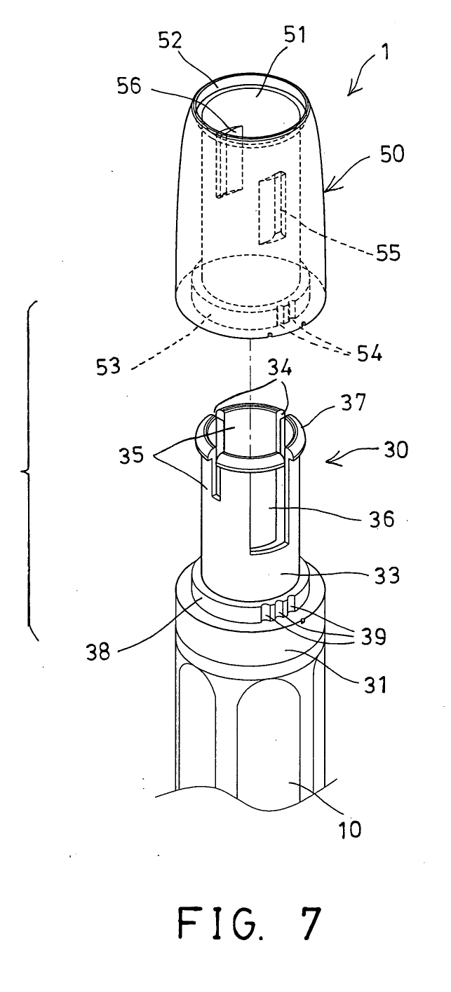

For example, the fixed coupler 30 includes a base portion 31 engaged onto the base tube 10 and secured to the base tube 10 with such as a rivet 32 or other fasteners, alternatively, as shown in FIG. 7, the base tube 10 may also be formed integral with the base portion 31 of the fixed coupler 30. The fixed coupler 30 further includes a sleeve member 33 provided or extended upwardly from the base portion 31 for engaging onto or for receiving the extending tube 90, best shown in FIG. 2.

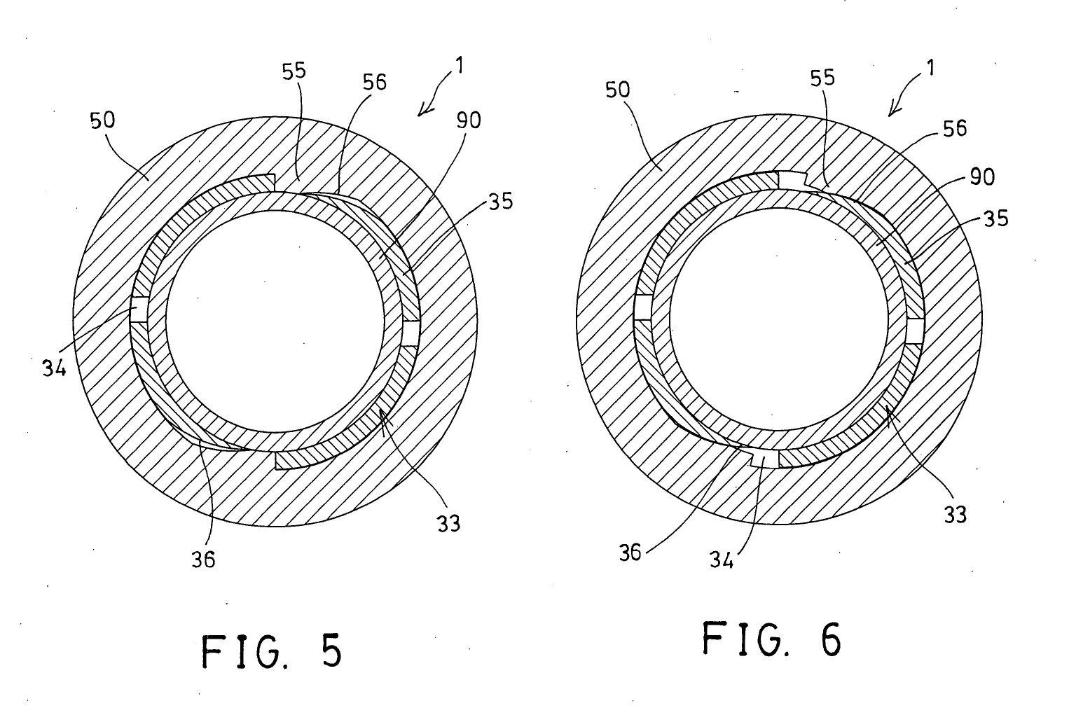

The sleeve member 33 includes one or more longitudinal slots 34 formed in the peripheral portion thereof for forming or defining one or more spring or flexible blades 35, in which the spring or flexible blades 35 each includes a suitable resilience for resiliently engaging onto the extending tube 90, and the spring or flexible blades 35 each includes an inclined surface 36 formed thereon and preferably tilted or inclined toward the respectively slot 34, best shown in FIGS. 5 and 6.

The sleeve member 33 further includes a peripheral flange 37 extended radially and outwardly from the upper portion thereof for anchoring purposes which will be discussed hereinafter, and includes a peripheral swelling 38 extended between the base portion 31 and the sleeve member 33 and having an outer diameter smaller than that of the base portion 31 but greater than that of the sleeve member 33, and the peripheral swelling 38 includes one or more cavities 39 formed therein.

The rotatable coupler 50 is in the form of a rotatable control ferrule and includes a bore 51 formed therein for receiving or for engaging onto the sleeve member 33, and includes a peripheral recess 52 formed in the upper portion thereof and communicating with the bore 51 thereof for rotatably or slidably receiving the peripheral flange 37 of the sleeve member 33, and thus for rotatably anchoring the rotatable coupler 50 to the sleeve member 33 of the fixed coupler 30 and for preventing the rotatable coupler 50 from being disengaged from the fixed coupler 30.

The rotatable coupler 50 further includes a peripheral depression 53 formed in the lower portion thereof and communicating with the bore 51 thereof for rotatably or slidably receiving the peripheral swelling 38 of the fixed coupler 30 and for guiding the rotatable coupler 50 to smoothly rotate relative to the fixed coupler 30, and includes one or more projections 54 extended into the peripheral depression 53 thereof for selectively engaging with the cavities 39 of the fixed coupler 30 and for anchoring and positioning the rotatable coupler 50 to the fixed coupler 30 at selected angular positions.

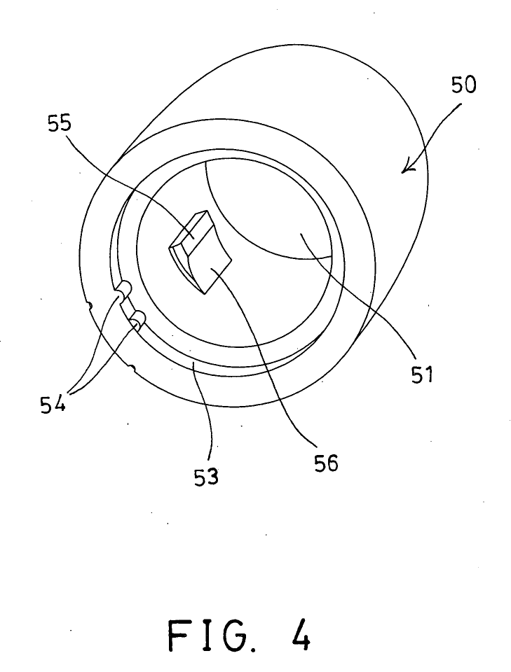

The rotatable coupler 50 further includes one or more actuators or protrusions 55 extended into the bore 51 thereof (FIG. 4) for selectively engaging with the blades 35 of the fixed coupler 30. For example, the protrusions 55 each includes an inclined surface 56 formed thereon for engaging with the corresponding inclined surface 36 of the blades 35 of the fixed coupler 30, and for allowing the protrusions 55 to be rotated and engaged onto the blades 35 of the fixed coupler 30.

When the blades 35 of the fixed coupler 30 are forced to engage with the extending tube 90, as shown in FIG. 6, the fixed coupler 30 and the extending tube 90 may be solidly forced and secured together with the rotatable coupler 50. The projections 54 of the rotatable coupler 50 may be engaged with the cavities 39 of the fixed coupler 30 for anchoring and positioning the rotatable coupler 50 to the fixed coupler 30 at selected angular positions or for maintaining the protrusions 55 of the rotatable coupler 50 in engagement with the blades 35 of the fixed coupler 30.

It is to be noted that, as best shown in FIGS. 5 and 6, the annular space between the rotatable coupler 50 and the extending tube 90 is good enough for receiving the sleeve member 33 of the fixed coupler 30 only such that the rotational movement of the rotatable coupler 50 relative to the sleeve member 33 of the fixed coupler 30 and the extending tube 90 is limited, and such that the rotatable coupler 50 may be prevented from being over-rotated relative to the sleeve member 33 of the fixed coupler 30.

In addition, the peripheral flange 37 of the sleeve member 33 may be engaged with the rotatable coupler 50 for rotatably anchoring the rotatable coupler 50 to the sleeve member 33 of the fixed coupler 30 and for preventing the rotatable coupler 50 from being disengaged from the fixed coupler 30 even when the protrusions 55 of the rotatable coupler 50 are not rotated and forced to engage onto the blades 35 of the fixed coupler 30, and for preventing the rotatable coupler 50 from being lost. The tubes 10, 90 of the same outer diameters may thus be adjustably secured together with the couplers 30, 50.

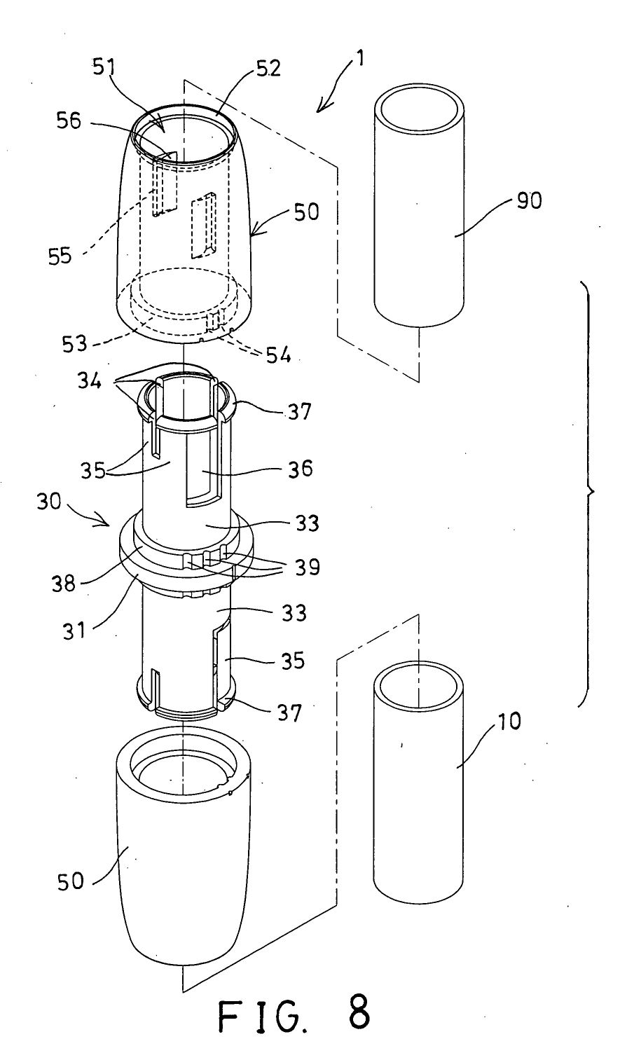

Alternatively, as shown in FIG. 8, the fixed coupler 30 may include another sleeve member 33 provided or extended downwardly from the base portion 31 for engaging onto or for receiving the base tube 10 and for detachably securing to the base tube 10 with another rotatable coupler 50. The extendible cleaner rod may be used for various cleaning apparatuses or sprayer facilities or mops or the like.

Accordingly, the extendible cleaner rod in accordance with the present invention includes two tubes extendible and adjustable relative to each other and releaseably or detachably secured together with a rotatable coupler that is limited to rotate relative to the tubes and that may be rotatably anchored to one of the tubes.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An extendible cleaner rod comprising:
a fixed coupler including a base portion for attaching to a base tube, and including a sleeve member extended from said base portion, said sleeve member including at least one slot to form at least one blade, said at least one blade including an inclined surface formed thereon,
an extending tube engaged into said, sleeve member of said fixed coupler, and
a rotatable coupler including a bore for rotatably engaging onto said sleeve member of said fixed coupler and including at least one protrusion extended into said bore of said rotatable coupler, said at least one protrusion including an inclined surface for engaging with said inclined surface of said at least one blade of said fixed coupler and for allowing said at least one protrusion to be rotated and engaged onto said at least one blade of said fixed coupler and for allowing said fixed coupler and said extending tube to be forced and secured together with said rotatable coupler.

2. The extendible cleaner rod as claimed in claim 1, wherein said fixed coupler includes a flange extended from said sleeve member for engaging with said rotatable coupler and for rotatably anchoring said rotatable coupler to said sleeve member of said fixed coupler and for preventing said rotatable coupler from being disengaged from said fixed coupler.

3. The extendible cleaner rod as claimed in claim 1, wherein said fixed coupler includes at least one cavity formed therein, and said rotatable coupler includes at least one projection for selectively engaging with said at least one cavity of said fixed coupler and for anchoring and positioning said rotatable coupler to said fixed coupler at a selected angular position.

4. The extendible cleaner rod as claimed in claim 3, wherein said fixed coupler includes a peripheral swelling having said at least one cavity formed in said peripheral swelling, and said rotatable coupler includes a peripheral depression for slidably receiving said peripheral swelling of said fixed coupler and for guiding said rotatable coupler to rotate relative to said fixed coupler.
